(19) United States
(12) Patent Application Publication
(10) Pub. No.: US 2015/0367712 A1
(43) Pub. Date: Dec. 24, 2015

(54) REMOVABLE CLIP TO SECURE A VEHICULAR SUN VISOR IN THE OPEN OR CLOSED POSITION

(71) Applicant: Willie Litonjua Lansang, Artesia, CA (US)

(72) Inventor: Willie Litonjua Lansang, Artesia, CA (US)

(21) Appl. No.: 14/717,783

(22) Filed: May 20, 2015

Related U.S. Application Data
(60) Provisional application No. 62/016,486, filed on Jun. 24, 2014.

(51) Int. Cl. B60J 3/02; F16B 2/22

(52) U.S. Cl. CPC B60J 3/023; F16B 2/22

(57) ABSTRACT

A removable clip for use with a sun visor in a vehicle to maintain the visor in an open position against a windshield of the vehicle or a closed position against an interior roof portion of the vehicle is provided. The clip includes a bar member having a first elongated member, a bend portion, and a second elongated member. The first elongated member is coupled to a first end of the bend portion, the second elongated member is coupled to a second end of the bend portion. The bend portion has a path with a bend of at least 180 degrees to create sufficient space between the first elongated member and the second elongated member to receive the sun visor. A first grip layer is disposed around the second elongated member and a second grip layer is disposed around the first elongated member.

### RELATED APPLICATION

The application claims priority to provisional patent application U.S. Ser. No. 62/016,486 filed on Jun. 24, 2014, the entire contents of which is herein incorporated by reference.

### BACKGROUND

The embodiments herein relate generally to sun visors used in vehicles.

Sun visors used in vehicles such as automobiles and trucks prevent the sun's rays from reaching the driver's eyes. The sun visor typically comprises a fabric opaque flap that is pivotably and/or rotatably mounted via a hinge to the vehicle's windshield area proximate the interior roof. The sun visor can be adjusted to the closed position where the visor contacts the interior roof of the vehicle. Alternatively, the visor can be adjusted to the open position where the visor contacts an upper portion of the vehicle's windshield, thereby blocking sun rays from entering through the windshield and into the driver's field of sight.

A common problem faced by vehicle drivers is that the sun visor droops down and fails to remain in the closed position. This can occur either due to a faulty visor hinge and/or wear and ultimate failure of the components such as the hinge. This is problematic because a sun visor that droops down unintentionally is a nuisance to the driver and/or blocks a portion of the driver's view, which is a safety hazard.

As such, there is a need in the industry for a removable clip that allows a user to support a vehicle's sun visor in either the closed or open position.

### SUMMARY

A removable clip for use with a sun visor in a vehicle to maintain the visor in an open position against a windshield of the vehicle or a closed position against an interior roof portion of the vehicle is provided. The removable clip comprises a bar member comprising a first elongated member comprising a first end and a second end, a bend portion, and a second elongated member comprising a first end and a second end, the second end of the first elongated member coupled to a first end of the bend portion, the first end of the second elongated member coupled to a second end of the bend portion, wherein the bend portion comprises a path with a bend of at least 180 degrees to create sufficient space between the first elongated member and the second elongated member to receive the sun visor, a first grip layer disposed around a portion of the second elongated member, and a second grip layer disposed around a first portion of the first elongated member, wherein the sun visor is disposed in the space between the first elongated member and the second elongated member, thereby maintaining the sun visor in the open or closed position.

In certain embodiments of the invention, the removable clip can be used to secure a variety of accessories to the vehicle's sun visor. As such, the clip can be used as a storage device for items that helps a user to organize and prevent a loss of one or more accessories.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the removable clip shown in use to secure the visor in the closed position;

FIG. 2 depicts a perspective view of certain embodiments of the removable clip;

FIG. 3 depicts a perspective view of certain embodiments of the removable clip;

FIG. 4 depicts a section view of certain embodiments of the removable clip, taken along line 4-4 in FIG. 2;

FIG. 5 depicts a section view of certain embodiments of the removable clip, taken along line 5-5 in FIG. 1;

FIG. 6 depicts a perspective view of certain embodiments of the removable clip shown in use to secure the visor in the open position; and

FIG. 7 depicts a perspective view of certain embodiments of the removable clip shown in use to secure accessories to the visor.

### DETAILED DESCRIPTION OF CERTAIN EMBODIMENTS

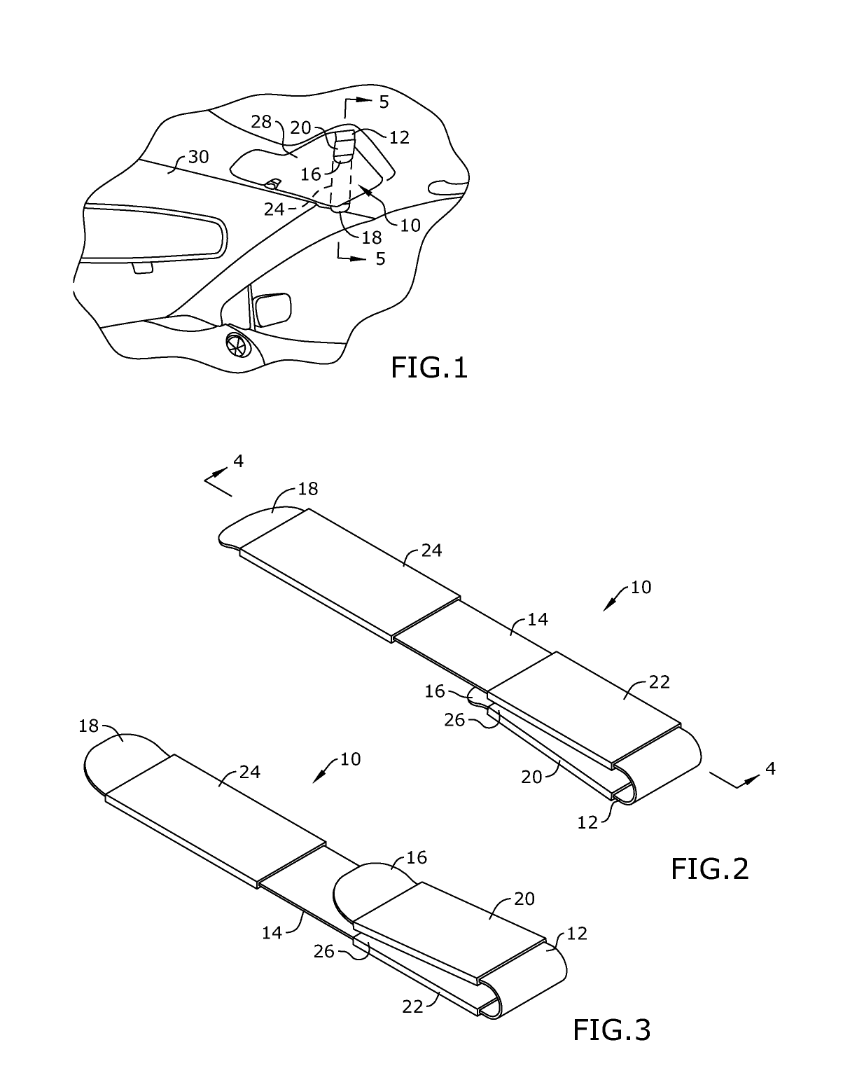

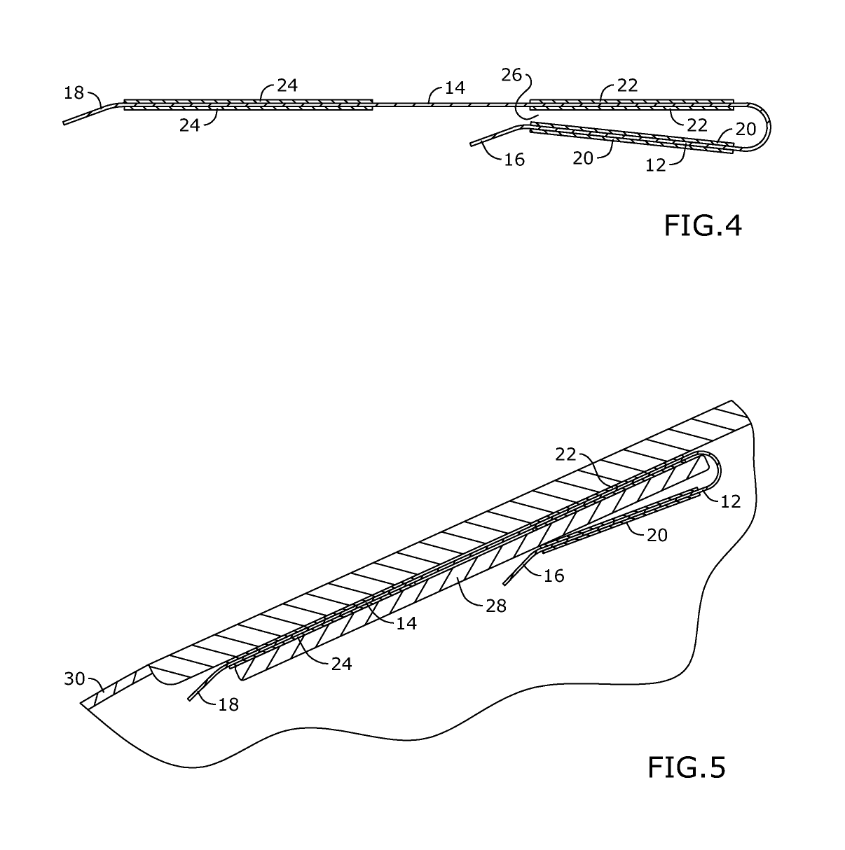

As depicted in FIG. 1, visor clip 10 is configured for use with visor 28 positioned near windshield 30 of a vehicle. Visor clip 10 is designed to secure visor 28 in the closed position against an interior roof portion of the vehicle or an open position against windshield 30. As depicted in FIGS. 2-4, visor clip 10 comprises short bar 12, long bar 14, short bar leg 16, long bar leg 18, first long bar grip layer 22, second long bar grip layer 24 and short bar grip layer 20.

Long bar 14 is connected to short bar 12 by a bend portion that comprises a path with a bend of at least 180 degrees. In a preferred embodiment long bar leg 18, long bar 14, the bend portion, short bar 12 and short bar leg 16 are part of a single component made from a malleable piece of 16-18 gauge metal such as galvanized steel. However, other metals, molded plastics, or alternative materials may be used instead. In a preferred embodiment, long bar leg 18 and long bar 14 has a combined length of approximately 10″. However, generally this length can be within the range of 5″-15″. In a preferred embodiment, short bar leg 16 and short bar 12 has a combined length of approximately 4½″. However, generally this length can be within the range of 2″-7″. Slot 26 between short bar 12 and long bar 14 is sufficiently large to receive visor 28.

Short bar leg 16 and short bar 12 are oriented at an angle of approximately 10-45 degrees relative to each other. This angled positioning of short bar leg 16 creates additional space between short bar leg 16 and long bar 14 to allow visor 28 to slide through with ease to the final position between long bar 14 and short bar 12. Similarly, long bar leg 18 and long bar 14 are oriented at an angle of approximately 10-45 degrees relative to each other.

Short bar grip layer 20 is disposed around short bar 12. Similarly, first long bar grip layer 22 and second long bar grip layer 24 are disposed around long bar 14. Alternatively, it shall be appreciated that a single and continuous grip layer may be disposed around long bar 14, the bend portion and short bar 12. In a preferred embodiment, the bar grip layers 20, 22, 24 may be any type of rubber, silicone, plastic, or alternative material designed to enhance the grip between visor clip 10 and visor 28. In addition, bar grip layers 20, 22, 24 protect visor clip 10 and prevent premature wear and tear associated with use. The overall weight of visor clip 10 is preferably between 6-7 ounces. However, the weight can also vary to any alternative range such as 2-16 ounces.

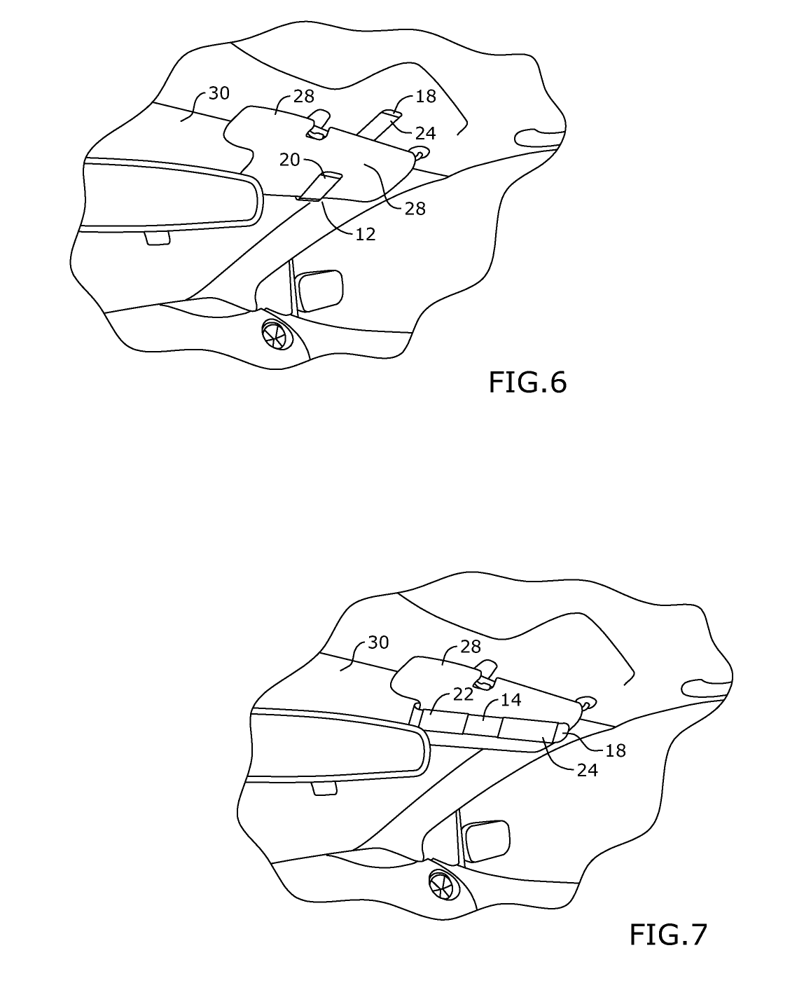

In operation, visor 28 is placed within visor clip 10 to maintain the visor in the closed position as depicted in FIG. 1. As depicted in FIG. 5, a portion of visor 28 is placed within short bar 12 and long bar 14. Bar grip layers 20, 22, 24 provide friction to secure visor clip 10 and visor 28 together and prevent the components from slipping against each other. Long bar 14 contacts windshield 30 and/or the interior roof of the vehicle, and uses the weight of visor clip 10 and visor 28 to pin visor 28 in the closed position. As depicted in FIG. 6, visor clip 10 can be positioned in a reverse configuration to secure visor 28 in the open position against windshield 30. Long bar 14 contacts windshield 30 and the interior roof of the car, and uses the weight of visor clip 10 and visor 28 to pin visor 28 in the open position.

In an alternative embodiment of the invention, visor clip 10 may be used to secure any number of accessories to visor 28. As depicted in FIG. 7, visor clip 10 is positioned along the length of visor 28. This permits accessories (not shown) to be placed between long bar 14 and visor 28. Any type of accessories may be secured to visor 28 including, but not limited to, paperwork, blueprints, magazines, newspapers, money, wallets, or the like. It an alternative embodiment, hook and/or loop fasteners may be secured to visor clip 10 to permit an attachment of other items thereto.

It shall be appreciated that the components of visor clip 10 described in several embodiments herein may comprise any alternative known materials in the field and be of any color, size and/or dimensions. It shall be appreciated that the components of visor clip 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A removable clip for use with a sun visor in a vehicle to maintain the visor in an open position against a windshield of the vehicle or a closed position against an interior roof portion of the vehicle, the removable clip comprising:
a bar member comprising:
a first elongated member comprising a first end and a second end,
a bend portion, directly attached to the second end first elongated member, and
a second elongated member comprising a first end and a second end, wherein the first end of the second elongated member is directly attached to the bend portion such that the second elongated member bends toward the first elongated member;
a first leg, directly attached to the first end of the first elongated member and bending away from the first elongated member and the second elongated member;
a second leg, directly attached to the first end of the second elongated member and bending away from the first elongated member and the second elongated member while bending toward the first leg
wherein the bend portion comprises a path with a bend of at least 180 degrees to create sufficient space between the first elongated member and the second elongated member to receive the sun visor;
a first grip layer disposed around a portion of the second elongated member; and
a second grip layer disposed around a first portion of the first elongated member;
wherein the sun visor is disposed in the space between the first elongated member and the second elongated member, thereby maintaining the sun visor in the open or closed position.

2. The removable clip of claim 1, further comprising a third grip layer disposed around a second portion of the first elongated member.

3. The removable clip of claim 2, wherein the length of the first elongated member is greater than the length of the second elongated member.

4. The removable clip of claim 3, wherein the first grip layer, the second grip layer and the third grip layer comprise a rubberized material.

5. The removable clip of claim 3, wherein the first grip layer, the second grip layer and the third grip layer comprise a silicone material.

6. (canceled)

7. The removable clip of claim 1, wherein a first angle defined by a longitudinal axis of the first elongated member and a longitudinal axis of the first leg is approximately 10 to 45 degrees.

8. The removable clip of claim 7, wherein a second angle defined by a longitudinal axis of the second elongated member and a longitudinal axis of the second leg is approximately 10 to 45 degrees.
